(19) United States
(12) Patent Application Publication
(10) Pub. No.: US 2003/0063049 A1
(43) Pub. Date: Apr. 3, 2003

(54) Method and device for controlling plasma display panel power consumption

(76) Inventors: Yoon-Phil Eo, Cheonan-city (KR); Nam-Sung Jung, Yongin-city (KR); Geun-Yeong Chang, Suwon-city (KR); Cheol-Hong Kim, Hwasung-kun (KR); Se-Woong Kim, Cheonan-city (KR)

Correspondence Address: CHRISTIE, PARKER & HALE, LLP, 350 WEST COLORADO BOULEVARD, SUITE 500, PASADENA, CA, 91105, US

(21) Appl. No.: 10/246,906

(22) Filed: Sep. 19, 2002

(30) Foreign Application Priority Data
Sep. 28, 2001 (KR) 2001-60740

(51) Int. Cl. G09G 3/28

(52) U.S. Cl. 345/60

(57) ABSTRACT

A plasma display panel (PDP) power consumption controlling method by varying a number of sustain pulses according to a load ratio (L/R) includes setting a safety operating area (SOA) on the number of sustain pulses according to the L/R, and controlling the power consumption within the SOA. The entire range of the number of sustain pulses has an upper and a lower boundary value, and a number of sustain pulses corresponding to the respective L/R sections is established. When the L/R is the previous number of sustain discharging pulses and it digresses from the SOA, the number of sustain discharging pulses is converged to the upper boundary value when the L/R has increased, and is converged to the lower boundary value when the L/R has decreased.

### CROSS-REFERENCE TO RELATED APPLICATIONS

This application claims priority to and the benefit of Korean Application No. 2001-0060740, filed on Sep. 28, 2001 in the Korean Patent Office, the entire disclosure of which is incorporated herein by reference.

### BACKGROUND OF THE INVENTION

(a) Field of the Invention

The present invention relates to a method and device for controlling power consumption of a plasma display panel (PDP). More specifically, the present invention relates to a method and device for controlling power consumption of a PDP by presetting a safety operating area (SOA) and when a power curve digresses from the SOA controlling the power curve to return to the SOA so that the power consumption may be always within the SOA.

(b) Description of the Related Art

Since a PDP has high power consumption because of its driving features, it requires a device for controlling the power consumption according to load ratios (L/R) of frames to be displayed.

Conventionally, numbers of sustain pulses are modified according to the L/R (or average signal levels) so as to control the power consumption.

FIG. 1 shows a conventional power control algorithm. Referring to FIG. 1, the entire region of the load ratio L/R is divided into n load ratio sections 0˜L₁, L₁˜L₂, . . . , Lₙ₋₁˜Lₙ, and the numbers Nₙ, Nₙ₋₁, . . . , N₁ of displaying and discharging corresponding to the respective load ratio sections 0˜L₁, L_{1˜L}₂, . . . , Lₙ₋₁˜Lₙ. For example, the maximum number Nₙ of displaying and discharging is applied to the frame belonging to the minimum section of the load ratio 0˜L₁. On the contrary, the minimum number N₁ of displaying and discharging is applied to the frame belonging to the maximum section of the load ratio Lₙ₋₁˜Lₙ.

According to the above-described conventional power control method, in the case where a screen is switched while a user views moving pictures, the luminance is greatly changed, which causes image deterioration.

### SUMMARY OF THE INVENTION

In accordance with the present invention a method and device is provided for preventing abrupt changes of the luminance of a PDP screen, and for improving image quality, in a method for controlling the PDP power consumption.

In one aspect of the present invention, a method for controlling power consumption of a PDP by varying a number of sustain pulses according to a load ratio (L/R), includes: (a) setting a safety operating area (SOA) of the number of sustain pulses according to the L/R; and (b) controlling the power consumption within the SOA.

The entire range of the number of sustain pulses is set to have an upper boundary value and a lower boundary value, and a number of sustain pulses corresponding to respective L/R sections is established.

In another aspect of the present invention, a device for controlling power consumption of a PDP includes: a controller for generating an address signal, an X driving control signal, and a Y driving control signal according to an external image signal; an address driver for processing the address signal, generating a display data signal, and providing the display data signal to address electrode lines; an X driver for processing the X driving control signal and providing it to X electrode lines; and a Y driver for processing the Y driving control signal and providing it to Y electrode lines, the controller setting a safety operating area (SOA) of the number of sustain pulses according to an L/R, and controlling the power consumption within the SOA.

### BRIEF DESCRIPTION OF THE DRAWINGS

FIG. 1 shows a graph for illustrating a conventional power control method.

FIG. 2 shows a block diagram of a controller of a PDP according to one embodiment of the present invention.

FIG. 3 shows a configuration of a controller of FIG. 2.

FIG. 4(a) and 4(b) show a safety operating area established according to a method for controlling the power consumption of a PDP according to one embodiment of the present invention.

FIG. 5 shows a graph for illustrating a power control method applied to the power controller of FIG. 3.

FIG. 6 shows a flow chart of a method for controlling the power consumption of a PDP according to one embodiment of the present invention.

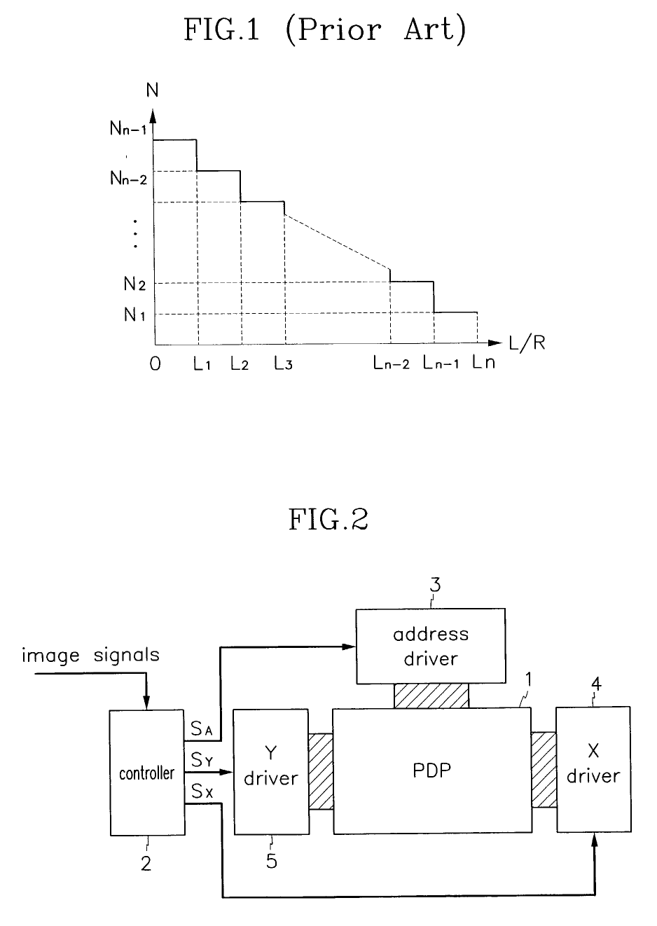

### DETAILED DESCRIPTION OF THE INVENTION

FIG. 2 shows a configuration of a PDP according to a preferred embodiment of the present invention. Referring to FIG. 2, a general driver of PDP 1 includes controller 2; address driver 3; X driver 4; and Y driver 5. Controller 2 generates driving control signals S_{A}, S_{Y}, and S_{X}, according to external image signals. Address driver 3 processes address signal S_{A} from among driving control signals S_{A}, S_{Y}, and S_{X} provided by controller 2 to generate a display data signal, and provides the display data signal to address electrode lines. X driver 4 processes X driving control signal S_{X} from among driving control signals S_{A}, S_{Y}, and S_{X} provided by controller 2, to provide it to X electrode lines. Y driver 5 processes Y driving control signal S_{Y} from among driving control signals S_{A}, S_{Y}, and S_{X} provided by controller 2, to provide it to Y electrode lines.

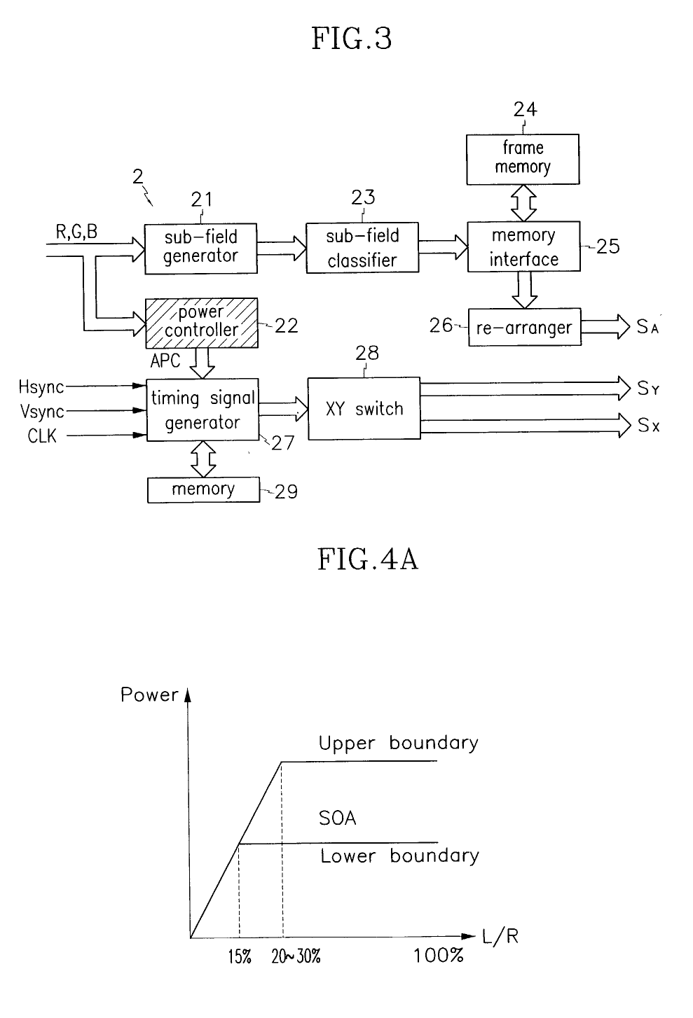

FIG. 3 shows a configuration of controller 2 of FIG. 2. Referring to FIG. 3, controller 2 includes sub-field generator 21; power controller 22; sub-field classifier 23; frame memory 24; memory interface 25; re-arranger 26; timing signal generator 27; XY switch 28; and memory 29.

Sub-field generator 21 converts input image data signals R, G, and B into gray data signals. Sub-field classifier 23 classifies the gray data signals provided by sub-field generator 21 according to gray levels. Memory interface 25 stores the data signals classified by sub-field classifier 23 in frame memory 24, and inputs the frame data provided by frame memory 24 to re-arranger 26. Re-arranger 26 rearranges the frame data input through memory interface 25 to fit them to a predetermined driving sequence and outputs address signal S_{A} as a result.

Timing signal generator 27 receives horizontal synchronization signal H_{SYNC</P>}, vertical synchronization signal V_{SYNC</P>}, and clock signals CLK included in the external image signals, and generates a timing signal according to the driving sequence constantly stored in memory 29, such as a programmable real only memory (PROM). XY switch 28, operable according to the predetermined driving sequence, switches the timing signals provided by timing signal generator 27 to output X driving control signal S_{X} and Y driving control signal S_{Y}.

In this instance, power controller 22 processes input image data signals R, G, and B to predict, for each frame, the L/R of the number of all discharged cells of PDP 1 of FIG. 2 to the number of discharged cells to be displayed and discharged, and inputs a corresponding discharging number automatic power control (APC) signal to timing signal generator 27. Accordingly, timing signal generator 27 controls the number of displaying and discharging pulses of a corresponding frame to be inversely proportional to the predicted L/R.

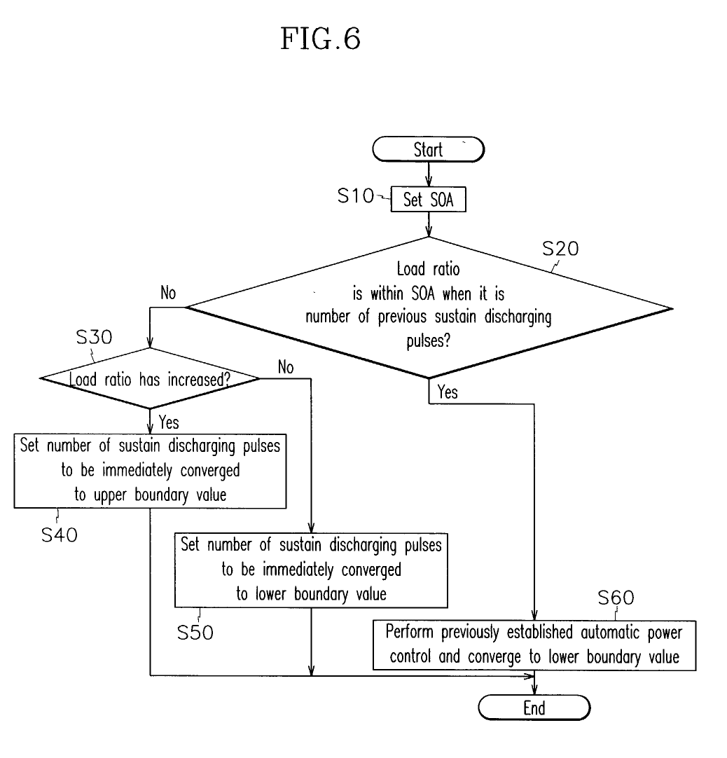

With reference to FIG. 6, an operation of power controller 22 will be described.

In setting a safety operating area by using the power controller, the entire range of the number of sustain pulses is set to have an upper boundary value and a lower boundary value, and a number of sustain pulses corresponding to respective load ratio sections is established in step S10.

In controlling the power consumption, it is determined whether the load ratio digresses from the safety operating area in step S20, and when it digresses from the SOA, it is determined whether the load ratio has increased in step S30, and the number of sustain discharging pulses is set to be converged to the upper boundary value when the load ratio has increased, and the number of sustain discharging pulses is set to be converged to the lower boundary value when the load ratio has decreased.

An operation of the power controller 22 will now be described in detail.

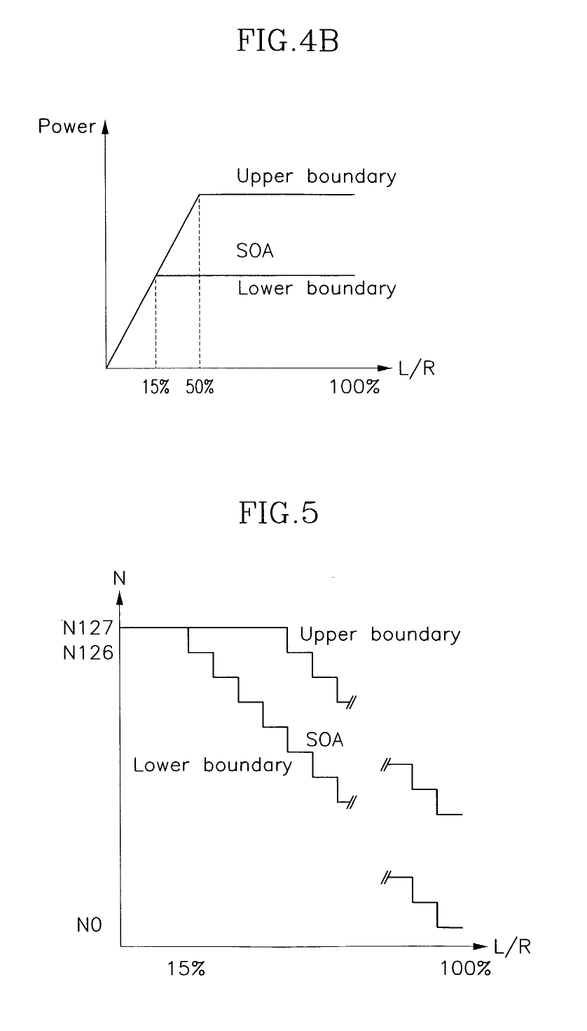

Referring now to FIGS. 4(a) and 4(b), there is shown a safety operating area established according to a method for controlling the power consumption of a PDP according to one embodiment of the present invention.

As shown by FIG. 4(a), a safety operating area (SOA) is predetermined, instead of a single power curve.

The SOA is controlled to have the L/R of a lower boundary value as 15%, and the L/R of an upper boundary value as 20 to 30% when the power consumption is 500W.

Further, as shown in FIG. 4(b), the SOA is controlled to have the L/R of a lower boundary value as 15%, and the L/R of an upper boundary value as 50% when the power consumption is 700W, which can be easily modified by a skilled person.

Referring to FIG. 5, there is shown a graph for illustrating a power control method applied to power controller 22 of FIG. 2. The entire range of the L/R is shown by 100%, and the numbers N0, N1, . . . , N127 of displaying and discharging corresponding to the respective L/R ranges are established.

Even when a load ratio of a present frame of moving pictures, that is, an average signal level, is instantaneously increased, the number of sustain discharging pulses is gradually decreased, and the luminance is gradually reduced.

Also, when the average signal level is abruptly reduced because of screen switching, causing digression from the safety operation area, the number of sustain discharging pulses is directly modified to a lower boundary value corresponding to the reduced average signal level, to generate its own luminance.

Further, in accordance with the present invention, transition time is increased by 0.5 seconds and is controlled to be modified step by step so as to prevent abrupt luminance variation.

In detail, when the L/R is changed, the previous number of sustain discharging pulses is sustained, and as it digresses from the safety operating area, the number of sustain discharging pulses is controlled using the upper or lower boundary value.

That is, when the L/R is increased, the number of sustain discharging pulses is controlled using the upper boundary value in step S40, and when the L/R is decreased, the number of sustain discharging pulses is controlled using the lower boundary value in step S50.

When the average signal level is less varied, the number of displaying and discharging corresponding to the L/R is applied according to a conventional method in step S60. That is, when the L/R is changed, the previous number of sustain discharging pulses is sustained, and if it stays in the safety operating area, the number of sustain discharging pulses is set to sustain a previously established automatic power control step for a predetermined time and be converged to a lower boundary value.

According to the display discharging number applied in this way, power controller 22 controls the power, and when a user views moving pictures and a screen is instantaneously switched, the corresponding luminance is not abruptly varied, and accordingly, the image quality is improved.

As described, in the case the screen of moving pictures is instantaneously switched, the luminance on the PDP screen is prevented from being greatly changed, thereby providing a method and device for improving image quality.

While this invention has been described in connection with a particular embodiment, it is to be understood that the invention is not limited to the disclosed embodiment, but, on the contrary, is intended to cover various modifications and equivalent arrangements included within the spirit and scope of the appended claims.

What is claimed is:

1. A method for controlling power consumption of a plasma display panel by varying a number of sustain pulses according to a load ratio, comprising:
setting a safety operating area of the number of sustain pulses according to the load ratio; and
controlling the power consumption within the safety operating area.

2. The method of claim 1, wherein in setting a safety operating area, the entire range of the number of sustain pulses is set to have an upper boundary value and a lower boundary value, and a number of sustain pulses corresponding to respective load ratio sections is established.

3. The method of claim 2, wherein in controlling the power consumption, when the load ratio is that of the previous number of sustain discharging pulses and it digresses from the safety operating area, the number of sustain discharging pulses is set to be converged to the upper boundary value when the load ratio has increased, and the number of sustain discharging pulses is set to be converged to the lower boundary value when the load ratio has decreased.

4. The method of claim 2, wherein when the load ratio is that of the previous number of sustain discharging pulses and it stays in the safety operating area, the number of sustain discharging pulses is set to sustain a previously established automatic power control step for a predetermined time and be converged to the lower boundary value.

5. A device for controlling power consumption of a plasma display panel, comprising:
a controller for generating an address signal, an X driving control signal, and a Y driving control signal according to an external image signal;
an address driver for processing the address signal, generating a display data signal, and providing the display data signal to address electrode lines;
an X driver for processing the X driving control signal and providing it to X electrode lines; and
a Y driver for processing the Y driving control signal and providing it to Y electrode lines, the controller setting a safety operating area of a number of sustain pulses according to a load ratio, and controlling the power consumption within the safety operating area.

6. The device of claim 5, wherein the controller sets the entire range of the number of sustain pulses to have an upper boundary value and a lower boundary value, and establishes the number of sustain pulses corresponding to respective load ratio sections.

7. The device of claim 6, wherein in the case the load ratio sustains that of the previous number of sustain discharging pulses and it digresses from the safety operating area, the controller sets the number of sustain discharging pulses to be converged to the upper boundary value when the load ratio has increased, and sets the number of sustain discharging pulses to be converged to the lower boundary value when the load ratio has decreased.

8. The device of claim 7, wherein when the load ratio sustains that of the previous number of sustain discharging pulses and it stays in the safety operating area, the controller sets the number of sustain discharging pulses to sustain a previously established automatic power control step for a predetermined time and be converged to the lower boundary value.

9. A plasma display panel, comprising:
a controller for generating an address signal, an X driving control signal, and a Y driving control signal according to an external image signal;
an address driver for processing the address signal, generating a display data signal, and providing the display data signal to address electrode lines;
an X driver for processing the X driving control signal and providing it to X electrode lines; and
a Y driver for processing the Y driving control signal and providing it to Y electrode lines, and
the controller includes:
a sub-field generator for converting input image data signals R, G, and B into gray data signals;
a sub-field classifier for classifying the gray data signals provided by the sub-field generator according to gray levels;
a frame memory for storing data;
a memory interface for storing the data signals classified by the sub-field classifier in the frame memory, and outputting the frame data provided by the frame memory;
a re-arranger for rearranging the frame data input through the memory interface to fit them to a predetermined driving sequence, and outputting a result, that is, an address signal;
a timing signal generator for generating a timing signal according to a horizontal synchronization signal, a vertical synchronization signal, and clock signals included in external image signals, and according to the driving sequence constantly stored in a memory;
an XY switch, operable according to the predetermined driving sequence, for switching the timing signal provided by the timing signal generator to output an X driving control signal and a Y driving control signal; and
a power controller for processing the input image data signals R, G, and B to predict, for each frame, a load ratio of the number of all discharged cells of the plasma display panel to the number of discharged cells to be displayed and discharged, and inputting a corresponding discharging number control signal to the timing signal generator so that the timing signal generator controls the number of displaying and discharging of a corresponding frame to be inversely proportional to the predicted load ratio, and setting a safety operating area of the number of the sustain pulses according to the load ratio, and controlling the power consumption within the safety operating area.
